(19) United States
(12) Patent Application Publication
(10) Pub. No.: US 2026/0349905 A1
(43) Pub. Date: Nov. 5, 2026

(54) INFORMATION PROCESSING SYSTEM, INFORMATION PROCESSING METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Tadahiro TAKAZAWA, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/115,541

(22) PCT Filed: Sep. 11, 2023
(86) PCT No.: PCT/JP2023/032993

§ 371 Date: Mar. 26, 2025

(30) Foreign Application Priority Data
Sep. 28, 2022 (JP) 2022-155082

(51) Int. Cl. G06F 11/3668

(52) U.S. Cl. CPC G06F 11/3672

(57) ABSTRACT

An information processing system of this disclosure is for supporting development of software to be executed by an in-vehicle device. The information processing system includes a control unit configured to add, to a queue for waiting for task test execution, a task provided from a repository storing a plurality of source code components included in the software. The control unit reads, from a storage, priority information including information regarding the provided task, calculates a priority level for the provided task based on the priority information, compares the priority level of a task already held in the queue with the priority level of the provided task to be newly added to the queue, and adds the provided task to the queue in such a manner that a task with a higher priority level is executed earlier in an execution order.

### CROSS-REFERENCE TO RELATED APPLICATIONS

This application is the U.S. national stage of PCT/JP2023/032993 filed on Sep. 11, 2023, which claims priority of Japanese Patent Application No. JP 2022-155082 filed on Sep. 28, 2022, the contents of which are incorporated herein.

### TECHNICAL FIELD

The present disclosure relates to an information processing system, an information processing method, and a computer program.

### BACKGROUND

Conventionally, software development is sometimes carried out using techniques called continuous integration (CI) and continuous delivery (CD). Continuous deployment (CD) is sometimes implemented instead of continuous delivery. With such development techniques, software under development is frequently subjected to automatic verification in order to suppress the occurrence of large-scale revision events and reduce cost associated with revision.

For example, at a software development site, developers individually create source code components, and the operation of each source code component is checked separately. However, when multiple source code components are integrated and run as a single piece of software, there is a risk of errors occurring. In this case, each pair of source code components needs to be verified in order to determine in which combination of components the error occurred, which may lead to a time-consuming operation test.

In development techniques that are based on CI/CD, for example, source code components individually created by developers are stored in a repository in the cloud (pushed to the repository). Each time a source code component is updated, a source code management (SCM) tool such as GitHub (registered trademark) automatically creates (builds) a task based on the source code stored in the repository. The task is automatically tested by a CI/CD tool such as Jenkins (registered trademark).

In this way, by repeatedly integrating source code components in small cycles and frequently checking for integration errors, it is possible to suppress large-scale revision.

JP 2010-134643A discloses a technology for selecting a test case to be executed based on test importance level and test execution time. In the technology of JP 2010-134643A, for example, test cases with a low importance level are not executed, thus making it possible to suppress the amount of time required for CI automatic testing.

JP 2021-105866A discloses a technology for changing the order of execution target information in an automatic execution queue based on, for example, a priority attribute included in attribute information of a ticket corresponding to a source code component.

The software executed by devices installed in vehicles such as automobiles (i.e., by in-vehicle devices) tends to become larger in scale every year, and development techniques based on CI/CD are also being adopted for software for in-vehicle devices.

Here, in the case of software for an in-vehicle device, it is necessary to use hardware resources such as development circuit boards and measuring tools to perform task operation tests. Providing a large number of such hardware resources increases the cost of constructing a test environment, and therefore the number of hardware resources has been limited. For this reason, it has been difficult to run a large number of operation tests in parallel for software for an in-vehicle device, and there is demand for the ability to more quickly find software revisions by executing tests of tasks in order of highest priority.

In view of the foregoing problem, an object of the present disclosure is to provide an information processing system, an information processing method, and a computer program capable of executing tests of tasks in order of highest priority.

### SUMMARY

An information processing system according to an aspect of the present disclosure is an information processing system for supporting development of software to be executed by an in-vehicle device, the information processing system including: a control unit configured to add, to a queue for waiting for task test execution, a task provided from a repository storing a plurality of source code components included in the software, wherein the control unit reads, from a storage, priority information including information regarding the provided task, the control unit calculates a priority level for the provided task based on the priority information, and the control unit compares the priority level of a task already held in the queue with the priority level of the provided task to be newly added to the queue, and adds the provided task to the queue in such a manner that a task with a higher priority level is executed earlier in an execution order.

An information processing method according to an aspect of the present disclosure is an information processing system for supporting development of software to be executed by an in-vehicle device, the information processing method including: an adding step of adding, to a queue for waiting for task test execution, a task provided from a repository storing a plurality of source code components included in the software, wherein the adding step includes a first step of reading, from a storage, priority information including information regarding the provided task, a second step of calculating a priority level for the provided task based on the priority information, and a third step of comparing the priority level of a task already held in the queue with the priority level of the provided task to be newly added to the queue, and adding the provided task to the queue in such a manner that a task with a higher priority level is executed earlier in an execution order.

A computer program according to an aspect of the present disclosure is a computer program for supporting development of software to be executed by an in-vehicle device, the computer program causing a computer to execute: an adding step of adding, to a queue for waiting for task test execution, a task provided from a repository storing a plurality of source code components included in the software, wherein the adding step includes a first step of reading, from a storage, priority information including information regarding the provided task, a second step of calculating a priority level for the provided task based on the priority information, and a third step of comparing the priority level of a task already held in the queue with the priority level of the provided task to be newly added to the queue, and adding the provided task to the queue in such a manner that a task with a higher priority level is executed earlier in an execution order.

### Advantageous Effects

According to the present disclosure, it is possible to execute tests of tasks in order of highest priority.

### BRIEF DESCRIPTION OF DRAWINGS

FIG. 1 is a diagram illustrating an example of an information processing system according to an embodiment.

FIG. 2 is a diagram illustrating an example of software according to the embodiment.

FIG. 3 is a diagram illustrating an example of the internal configuration of an information processing device according to the embodiment.

FIG. 4 is a diagram illustrating an example of a test environment according to the embodiment.

FIG. 5 is a table illustrating an example of version information according to the embodiment.

FIG. 6 is a table illustrating an example of execution time information according to the embodiment.

FIG. 7 is a table illustrating an example of required time information according to the embodiment.

FIG. 8 is a table illustrating an example of test result information according to the embodiment.

FIG. 9 is a table illustrating an example of safety standard information according to the embodiment.

FIG. 10 is a table illustrating an example of environment information according to the embodiment.

FIG. 11 is a flowchart illustrating an example of an information processing method according to the embodiment.

FIG. 12 is a flowchart illustrating an information processing method according to a modified example.

FIG. 13 is a diagram for describing priority levels of tasks according to a modified example.

FIG. 14 is a table illustrating test result information according to a modified example.

### DETAILED DESCRIPTION OF PREFERRED EMBODIMENTS

The gist of the present disclosure includes the following configurations.

In a first aspect, an information processing system according to an aspect of the present disclosure is an information processing system for supporting development of software to be executed by an in-vehicle device, the information processing system including: a control unit configured to add, to a queue for waiting for task test execution, a task provided from a repository storing a plurality of source code components included in the software, wherein the control unit reads, from a storage, priority information including information regarding the provided task, the control unit calculates a priority level for the provided task based on the priority information, and the control unit compares the priority level of a task already held in the queue with the priority level of the provided task to be newly added to the queue, and adds the provided task to the queue in such a manner that a task with a higher priority level is executed earlier in an execution order.

According to this configuration, tests of tasks can be executed in order of highest priority level.

In a second aspect, in the information processing system according to the first aspect, the in-vehicle device may include an in-vehicle ECU.

Software development for automotive ECUs tends to be large-scale, and therefore it is particularly useful to perform the test of a task with a higher priority level earlier.

In a third aspect, in the information processing system according to the first or the second aspect, the priority information may include information regarding at least one of a test environment, a past result of a test of a task, an execution time at which a test of a task was executed, and a required time indicating a duration of time required for execution of a test of a task.

The priority information includes the test environment information, for example, and therefore it is possible to determine an appropriate priority level that corresponds to the task.

In a fourth aspect, in the information processing system according to any of of the first through the third aspects, the priority information may include information regarding a vehicle safety standard required of a task.

The priority information includes information related to a vehicle safety standard, and therefore it is possible to determine an appropriate priority level that corresponds to the type of vehicle and the in-vehicle device installed in the vehicle.

In a fifth aspect, in the information processing system according to the third aspect, there may be a plurality of the tasks, including a first task and a second task whose most recent execution time is before a most recent execution time of the first task. In this case, the control unit may calculate a higher priority level for the second task than for the first task.

If the test of a task that has been left unexecuted is executed sooner, it is possible to suppress an increase in the scale of source revision.

In a sixth aspect, in the information processing system according to the third or the fifth aspect, there may be a plurality of the tasks, including a first task and a second task whose required time is shorter than a required time of the first task. In this case, the control unit may calculate a higher priority level for the second task than for the first task.

If the test of a task that can be executed in a shorter time is executed earlier, it is possible to increase the number of tests executed per unit time, and it is possible to reduce the number of tasks waiting to be executed.

In a seventh aspect, in the information processing system according to the third, fifth or sixth aspect, there may be a plurality of the tasks, including a first task whose most recent result is successful and a second task whose most recent result is failure. In this case, the control unit may calculate a higher priority level for the second task than for the first task.

If the test of a task that failed is executed earlier, it is possible to more quickly determine whether or not the error has been resolved.

In an eighth aspect, in the information processing system according to the third, fifth, sixth or seventh aspect, the test environment may include a test set including a circuit board and a measurement unit that measures operation of the circuit board, and an execution unit that executes a test of a task output from the queue, by controlling the test set based on the output task. In this case, the priority information may include environment information in which tasks are respectively associated with test sets used in tests of the tasks, and the control unit may calculate the priority level for the provided task based on the environment information.

Both the circuit board and the measurement unit are hardware resources. Providing a large number of test sets including such hardware resources increases the cost of constructing the test environment, and therefore there is demand for the ability to execute software operation tests using a limited number of test sets. As a result, when developing software for an in-vehicle device, it is difficult to execute a large number of the tasks in parallel. As a result, executing a task with a higher priority level earlier is particularly useful in finding software revisions more quickly.

In a ninth aspect, in the information processing system according to the eighth aspect, there may be a plurality of the test sets, including a plurality of first test sets and one or more second test sets, the number of second test sets being lower than the number of first test sets. In this case, there may be a plurality of the tasks, including a first task associated with a first test set among the plurality of first test sets in the environment information and a second task associated with a second test set among the one or more second test sets in the environment information, and the control unit may calculate a higher priority level for the second task than for the first task.

By executing a test that requires fewer test sets earlier, it is possible to reduce the idle time of the scarce test sets.

In a tenth aspect, in the information processing system according to the fourth aspect, there may be a plurality of the tasks, including a first task and a second task, the safety standard required of the second task being stricter than the safety standard required of the first task. In this case, the control unit may calculate a higher priority level for the second task than for the first task.

A task with a stricter safety standard has a narrower range of values permitted in the test, and is more susceptible to errors. By executing the test of such a task earlier, a source error can be found more quickly.

In an eleventh aspect, in the information processing system according to the tenth aspect, the safety standard includes ISO26262 Automotive Safety Integrity Levels.

In a twelfth aspect, in the information processing system according to any of the first through the eleventh aspects, the control unit may calculate a priority level for each a plurality of tasks already held in the queue based on the priority information, and the control unit may rearrange the plurality of tasks already held in the queue in such a manner that a fourth task having a higher priority level than a third task is executed before the third task in the execution order.

According to this configuration, it is possible to review the order in which tasks already in the queue are held, and therefore the test of a task with a higher priority level can be more reliably executed earlier.

In a thirteenth aspect, in the information processing system according to any of the first through the twelfth aspects, the control unit may divide the provided task into a plurality of divided tasks based on at least one of the test environment, the safety standard, the result, the execution time, and the required time, the control unit may calculate a priority level for each of the divided tasks based on the priority information, and the control unit may add the plurality of divided tasks to the queue in such a manner that a second divided task having a higher priority level than a first divided task is executed before the first divided task in the execution order.

According to this configuration, test results can be checked in more detail. This makes it easier to narrow down the portion of the task in which an error has occurred, thus making it possible to respond to the error more quickly.

In a fourteenth aspect, an information processing method according to an aspect of the present disclosure is an information processing system for supporting development of software to be executed by an in-vehicle device, the information processing method including: an adding step of adding, to a queue for waiting for task test execution, a task provided from a repository storing a plurality of source code components included in the software, wherein the adding step includes a first step of reading, from a storage, priority information including information regarding the provided task, a second step of calculating a priority level for the provided task based on the priority information, and a third step of comparing the priority level of a task already held in the queue with the priority level of the provided task to be newly added to the queue, and adding the provided task to the queue in such a manner that a task with a higher priority level is executed earlier in an execution order.

According to this configuration, tests of tasks can be executed in order of highest priority level.

In a fifteenth aspect, a computer program according to an aspect of the present disclosure is a computer program for supporting development of software to be executed by an in-vehicle device, the computer program causing a computer to execute: an adding step of adding, to a queue for waiting for task test execution, a task provided from a repository storing a plurality of source code components included in the software, wherein the adding step includes a first step of reading, from a storage, priority information including information regarding the provided task, a second step of calculating a priority level for the provided task based on the priority information, and a third step of comparing the priority level of a task already held in the queue with the priority level of the provided task to be newly added to the queue, and adding the provided task to the queue in such a manner that a task with a higher priority level is executed earlier in an execution order.

According to this configuration, tests of tasks can be executed in order of highest priority level.

Hereinafter, details of embodiments of the present disclosure will be described with reference to the drawings.

### Overall Configuration of Information Processing System

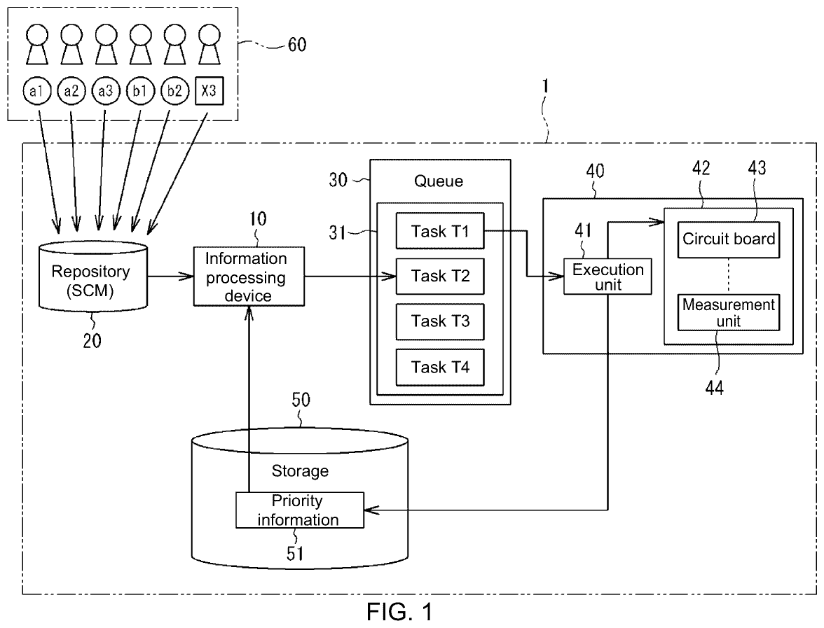

FIG. 1 is a diagram illustrating an example of the configuration of an information processing system 1 according to an embodiment.

The information processing system 1 is a system that supports the development of software SW1 that is executed in, for example, a device installed in a vehicle such as an automobile (hereinafter referred to as an “in-vehicle device”).

The software SW1 is software used in, for example, an in-vehicle ECU (Electronic Control Unit), which is an example of an in-vehicle device. More specifically, the software SW1 is used in a central ECU or an integrated ECU having a function of managing multiple ECUs. Software such as the software SW1 tends to involve large-scale development, and therefore development support provided by the information processing system 1 is particularly useful.

The information processing system 1 includes an information processing device 10, a repository 20, a test tool 30, a test environment 40, and a storage 50. The information processing system 1 may be realized by a single device (e.g., a server device) disposed at one location, or may be realized by multiple devices distributed among various locations, such as the units 10, 20, 30, 40, and 50 being connected to each other so that they can communicate with each other via a network such as the Internet.

### Software and Task

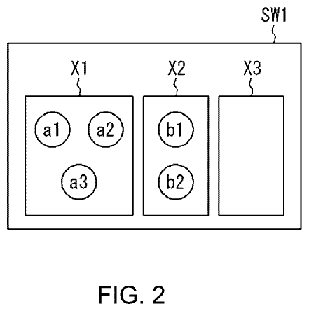

FIG. 2 is a diagram illustrating an example of the software SW1 according to the embodiment. The software SW1 and a task Tx will be described below with reference to FIG. 2. As described above, the software SW1 is software executed by an in-vehicle device. The software SW1 includes components X1, X2, and X3. The component X1 includes modules a1, a2, and a3, and the component X2 includes modules b1 and b2.

The components X1, X2, and X3 and the modules a1, a2, a3, b1, and b2 will collectively referred to as “source code components”. In other words, the software SW1 includes multiple source code components. These source code components may be data written in a certain programming language called source code, or may be data written in binary code obtained by converting source code into machine language.

For example, these source code components are created individually on multiple terminals (collectively referred to as a terminal group 60) operated by developers (suppliers). In the information processing system 1, operation testing is executed on each source code component, and operation testing is executed on integrations of multiple source code components. Here, a test item executed in the information processing system 1 is called a task Tx. The task Tx is also called a “job task”.

The task Tx includes any one of the following test items (1) to (4).
(1) Test item for verifying operation of a module (e.g., module a1) on its own.
(2) Test item for verifying operation of an integration of multiple modules contained in a single component (e.g., the module a1 and the module a2).
(3) Test item for verifying operation of a single component (e.g., the component X1), that is, verifying operation of an integration of all modules contained in the component (e.g., the modules a1, a2, and a3).
(4) Test item for verifying operation of an integration of multiple components (e.g., the component X1 and the component X2).

### Repository

Refer now to FIG. 1. The repository 20 is, for example, a database constructed in the cloud, and is realized by a mass storage device. The repository 20 is connected to the terminal group 60 via a network. Developers transmit source code components that they have created on terminals in the terminal group 60 to the repository via the network. The repository 20 stores the received source code components.

The repository 20 is accompanied by a source code management tool (also called an SCM tool) such as GitHub. The SCM automatically generates tasks Tx based on source code components stored in the repository 20. The generated tasks Tx are supplied from the repository 20 to the information processing device 10.

### Information Processing Device

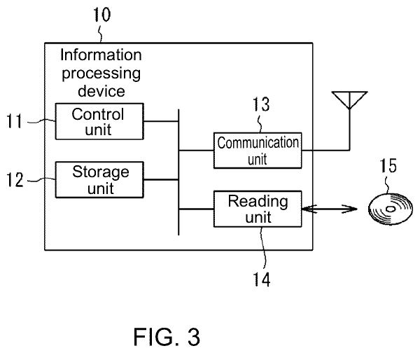

FIG. 3 is a diagram illustrating an example of the internal configuration of the information processing device 10 according to the embodiment.

The information processing device 10 is a device for executing processing of adding tasks Tx to a queue 31 managed by the test tool 30. The information processing device 10 includes a control unit 11, a storage unit 12, a communication unit 13, and a reading unit 14. These units 11 to 14 are electrically connected to each other via a bus.

The control unit 11 includes circuitry such as a processor. Specifically, the control unit 11 includes one or more central processing units (CPUs). The control unit 11 reads out a computer program stored in the storage unit 12 and executes various types of calculation and control.

Note that the control unit 11 may include a processor in which a predetermined program is written in advance. For example, the control unit 11 may be an integrated circuit such as a complex programmable logic device (CPLD), a field-programmable gate array (FPGA), or an application specific integrated circuit (ASIC). In this case, the control unit 11 executes various types of information processing based on a program written in advance.

The storage unit 12 has a volatile memory and a non-volatile memory, and stores various types of data. One example of a volatile memory is random access memory (RAM). Examples of a non-volatile memory include a flash memory, a hard disk drive (HDD), a solid state drive (SSD), and a read only memory (ROM). The storage unit 12 stores computer programs and various parameters in, for example, a non-volatile memory.

The communication unit 13 is a communication interface that executes communication with the repository 20, the test tool 30, and the storage 50. The communication unit 13 may perform wireless communication with the units 20, 30, and 50 via a network, or may perform wired communication with them via a communication line. In the case where wireless communication is performed, the communication unit 13 has an antenna.

The reading unit 14 reads information from a computer-readable recording medium 15. The recording medium 15 is, for example, an optical disk such as a CD or a DVD, or a USB flash memory. The reading unit 14 is, for example, an optical drive or a USB terminal. A computer program and various parameters are recorded on the recording medium 15, and when the reading unit 14 reads the recording medium 15, the computer program and various parameters are stored in the non-volatile memory of the storage unit 12.

A task Tx provided from the repository 20 is received by the communication unit 13 and input to the control unit 11 via the bus. Also, priority information 51, which will be described later, read from the storage 50 is also received by the communication unit 13 and input to the control unit 11 via the bus. The control unit 11 calculates the priority level of the task Tx based on the priority information 51, in accordance with a computer program read from the storage unit 12. The control unit 11 then adds the task Tx at a predetermined position in the queue 31 based on the calculated priority level.

### Test Tool

Refer now to FIG. 1. The test tool 30 is a CI/CD tool such as Jenkins or CircleCI (registered trademark), and is realized by a computer device that includes a processor and a memory. The test tool 30 manages the queue 31 in which a plurality of tasks Tx wait for test execution. Specifically, the test tool 30 automatically outputs the tasks Tx stored in the queue 31 to an execution unit 41 of the test environment 40 in sequence.

The queue 31 is, for example, a memory that stores tasks Tx in a first-in first-out (FIFO) manner. In the example of FIG. 1, four tasks Tx (hereinafter referred to as T1, T2, T3, and T4, when distinction between them is particularly needed) are stored in the queue 31.

FIG. 1 shows the case where the task T1, the task T2, and the task T3 are already stored in the queue 31 in the stated order, and the task T4 output from the information processing device 10 (specifically, the control unit 11) is added between the task T1 and the task T2 in the execution order, rather than in FIFO order. In this case, the test tool 30 outputs the tasks Tx stored in the queue 31 to an execution unit 41 in the order of tasks T1, T4, T2, and T3.

### Test Environment

Refer now to FIG. 1. The test environment 40 includes the execution unit 41 and a test set 42. The execution unit 41 is a computer device (e.g., a laptop PC) that includes a processor and a memory, and is also called a “node”. The execution unit 41 controls the test set 42 based on the tasks Tx output from the queue 31, thereby executing the tests of the tasks Tx. Also, the execution unit 41 collects information such as the results of the tests of the tasks Tx executed in the test set 42 (e.g., a history indicating the execution time of the test, the time required for execution, and whether the test was successful or failed), and outputs the collected information to the storage 50.

The test set 42 is a hardware resource that mimics the production environment in which the software SW1 operates. The software SW1 is so-called “embedded software” executed by an in-vehicle device, and therefore in order to test the operation of the software SW1, it is necessary to use a hardware resource that mimics the production environment, such as the test set 42. Specifically, the test set 42 includes a circuit board 43 and a measurement unit 44.

The circuit board 43 (also called a development board) is a board that mimics a circuit board incorporated in an in-vehicle device (e.g., a board implemented in an ECU). The circuit board 43 may be the actual circuit board that is incorporated in the in-vehicle device, or may be a prototype of the circuit board that is incorporated in the in-vehicle device. The measurement unit 44 is a tool that measures the operation of the circuit board 43. The measurement unit 44 is a communication software tool such as CANoe (registered trademark).

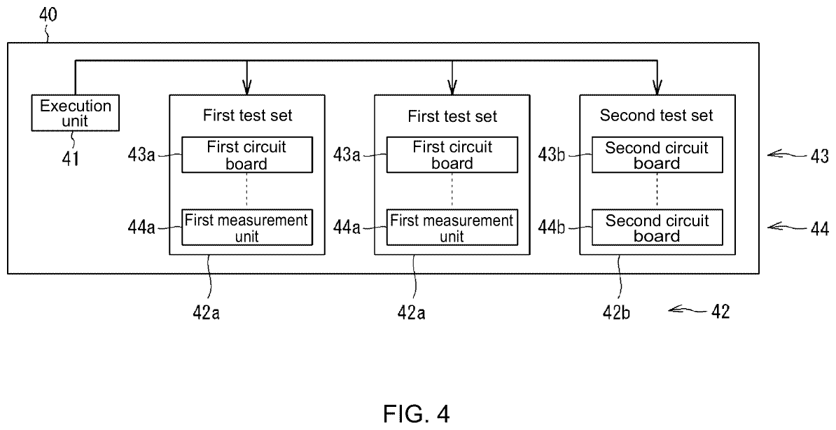

FIG. 4 is a diagram illustrating an example of the test environment 40 according to the embodiment. FIG. 4 illustrates the case where the test environment 40 includes a plurality of test sets 42. The test sets 42 include a plurality of (two in FIG. 4) first test sets 42a and a second test set 42b. The number of second test sets 42b is smaller than the number of first test sets 42a, and is one in FIG. 4. Note that the test sets 42 may include a plurality of second test sets 42b.

The circuit board 43 and the measurement unit 44 included in the first test set 42a will be referred to as a first circuit board 43a and a first measurement unit 44a. The first measurement unit 44a measures the operation of the first circuit board 43a. Similarly, the circuit board 43 and the measurement unit 44 included in the second test set 42b will be referred to as a second circuit board 43b and a second measurement unit 44b. The second circuit board 43b is a board having a different function from that of the first circuit board 43a. The second measurement unit 44b measures the operation of the second circuit board 43b.

Refer now to FIG. 1. Both the circuit board 43 and the measurement unit 44 are hardware resources and have low versatility. For example, the circuit board 43 is not a general-purpose board, but rather is a dedicated board adjusted for use with an in-vehicle device. In other words, the circuit board 43 and the measurement unit 44 are used exclusively for testing the software SW1, and tend to be expensive. Providing a large number of such test sets 42 increases the cost of constructing the test environment 40, and therefore there is desire for the ability to execute operation testing of the software SW1 using a limited number of test sets 42.

As a result, when developing the software SW1 for an in-vehicle device, it is difficult to execute a large number of tasks Tx in parallel, and there is desire for the ability to more quickly find revisions to be made to the software SW1 by executing the tests of the tasks Tx in order of highest priority.

In view of this, in the information processing system 1, when a task Tx is added to the queue 31, the task Tx is added at a position corresponding to the priority level of the task Tx, and therefore a test of a task Tx with a high priority can be executed at an earlier time.

### Storage

Refer now to FIG. 1. The storage 50 is an auxiliary storage device such as an HDD or an SSD. Priority information 51 is stored in the storage 50. The priority information 51 is information for calculating the priority level of a task Tx. The priority information 51 includes, for example, version information D1, execution time information D2, required time information D3, test result information D4, safety standard information D5, and environment information D6. Note that the priority information 51 may not include any of the types of information D1 to D6. In other words, the priority information 51 need only include at least one type of information among the information D1 to D6. Furthermore, the priority information 51 may include information other than the information D1 to D6.

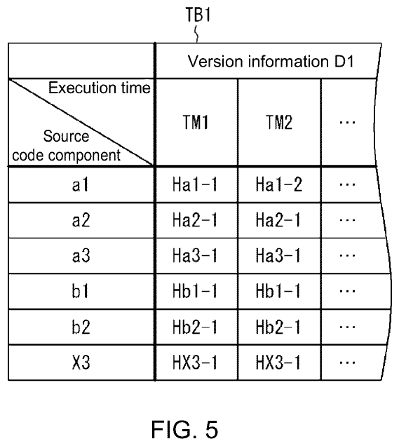

FIG. 5 is a table TB1 showing an example of the version information D1 according to the embodiment. The version information D1 is information regarding the versions of source code components at the time when the test of the task Tx was executed. The version information D1 is provided from the execution unit 41 to the storage 50, for example, every time the execution unit 41 executes the test of the task Tx. The version information D1 is shown as, for example, a hash value assigned to the source code component by the SCM (i.e., a value that is uniquely determined for the source code component).

In the example of FIG. 5, the version of the module a1 at a test execution time TM1 (e.g., the date and time when the test was executed) is shown as the hash Ha1-1, and the version of the module a2 at the execution time TM1 is shown as the hash H2-1. The version of the module a1 at an execution time TM2 later than the execution time TM1 (an execution time closer to the present time) is shown as the hash Ha1-2, and the version of the module a2 at the execution time TM1 is shown as the hash H2-1.

In other words, at the execution time TM2, the version of the module a1 had been updated from the hash Ha1-1 to the hash Ha1-2. In the example of FIG. 5, the source code components other than the module a1 are not updated between the execution time TM1 and the execution time TM2. Therefore, among the multiple source code components, the module a1 is the most recently updated source code component. In other words, by looking at the difference between hash values at a plurality of execution times in the version information D1, it is possible to determine which source code component has been most recently updated.

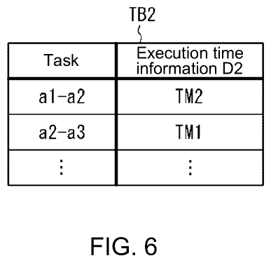

FIG. 6 is a table TB2 showing an example of the execution time information D2 according to the embodiment. The execution time information D2 is information in which a task Tx is associated with the execution time (most recent execution time) when the test of the task Tx was last executed. The execution time information D2 is provided from the execution unit 41 to the storage 50, for example, every time the execution unit 41 executes the test of a task Tx. In the example of FIG. 6, it is shown that an integration test for the modules a1 and a2 was last executed at an execution time TM2, and an integration test for the modules a2 and a3 was last executed at an execution time TM1. In other words, based on the execution time information D2, it is possible to determine which task Tx was executed most recently and which task Tx has been left unexecuted for a long time.

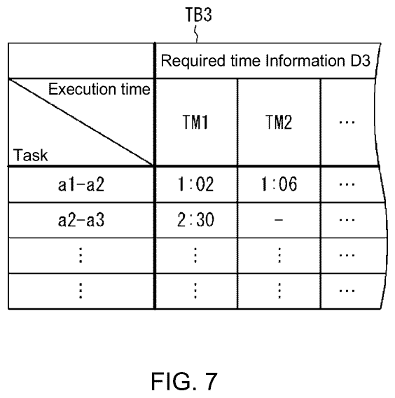

FIG. 7 is a table TB3 showing an example of the required time information D3 according to the embodiment. The required time information D3 is information in which a task Tx is associated with the time required to execute the test of the task Tx. The required time information D3 is provided from the execution unit 41 to the storage 50, for example, every time the execution unit 41 executes the test of the task Tx. In the table TB3 in FIG. 7, the required time is stored for each of the execution times TM1 and TM2. For example, it is shown that the integration test for the modules a1 and a2 required 1 minute and 2 seconds at the execution time TM1, and required 1 minute and 6 seconds at the execution time TM2. It is also shown that the integration test for the modules a2 and a3 required 2 minutes and 30 seconds at the execution time TM1, and that the integration test was not executed at the execution time TM2.

According to the required time information D3, it is possible to acquire the time required to execute the most recent test. For example, the most recent required time for the integration test for the modules a1 and a2 is 1 minute and 6 seconds, and the most recent required time for the integration test for the modules a2 and a3 is 2 minutes and 30 seconds. Furthermore, the required time information D3 can be used to obtain a statistical value (e.g., an average value or a median value) of the required times of past tests. For example, the average value of the required times for the past two integration tests for the modules a1 and a2 is 1 minute and 4 seconds.

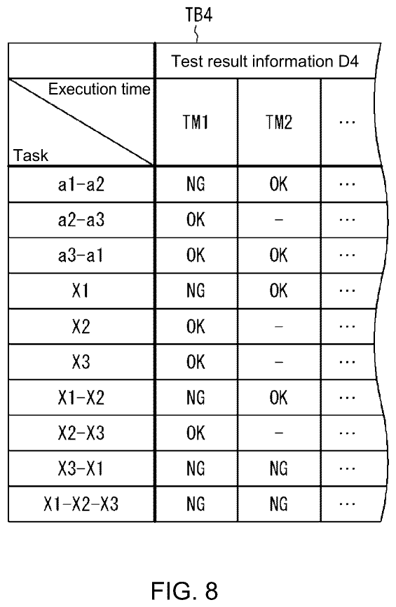

FIG. 8 is a table TB4 showing an example of the test result information D4 according to the embodiment. The test result information D4 is information in which tasks Tx are associated with the results of the tests of the tasks Tx. The test results include test failure (NG) and test success (OK). Here, a test failure includes, for example, a case where a desired measurement value condition is not met in the measurement unit 44. Also, a test success includes, for example, a case where all desired measurement value conditions are met in the measurement unit 44.

The table TB4 in FIG. 8 stores test results for each of the execution times TM1 and TM2. The test result information D4 is provided from the execution unit 41 to the storage 50, for example, every time the execution unit 41 executes the test of a task Tx. For example, it is shown that an integration test executed on the modules a1 and a2 failed at the execution time TM1 and was successful at the execution time TM2. It is also shown that an integration test executed on the modules a2 and a3 was successful at the execution time TM1, and that the integration test was not executed at the execution time TM2. Moreover, it is shown that an integration test executed on the components X3 and X1 failed at both of the execution times TM1 and TM2.

The result of the most recent test can be obtained from the test result information D4. For example, the most recent test result of the integration test executed on the modules a1 and a2 is success, and the most recent test result of the integration test executed on the modules a2 and a3 is success. In contrast, the most recent test result of the integration test executed on components X3 and X1 is failure. Furthermore, information on how many consecutive test failures have occurred in the past can be acquired from the test result information D4. For example, counting from the most recent test, the integration test executed on the components X3 and X1 has failed twice consecutively.

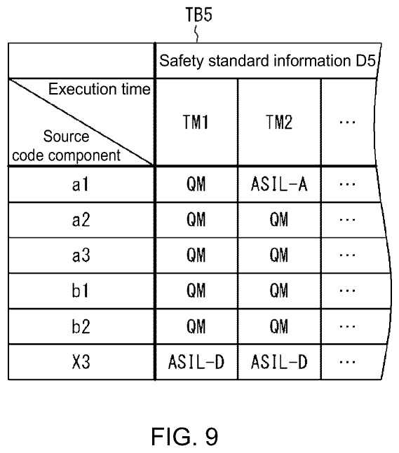

FIG. 9 is a table TB5 showing an example of the safety standard information D5 according to the embodiment. The safety standard information D5 is information regarding the safety standard required for a source code component at the time when the test of a task Tx is executed. The safety standard information D5 is provided from the execution unit 41 to the storage 50, for example, every time the execution unit 41 executes the test of a task Tx. The safety standard is, for example, a safety standard for vehicles, more specifically, for automobiles. One example of a safety standard is ISO26262 ASIL (Automotive Safety Integrity Level). ASIL is divided into several levels, such as QM, ASIL A, ASIL-B, ASIL-C, and ASIL-D, which are in order of increasingly strict requirements. In other words, QM has the most lenient requirements and ASIL-D has the most strict requirements.

In the example of FIG. 9, the safety standard of the module a1 at the execution time TM1 is shown as QM, and the safety standard of the module a1 at the execution time TM2 is shown as ASIL-A. In other words, it is shown that the safety standard of the module a1 was raised by one level when there was the update between the execution time TM1 and the execution time TM2 (FIG. 5).

In the case of the source code components other than the module a1, there is no update between the execution time TM1 and the execution time TM2, and therefore there is no change in the safety standards. For example, the safety standard of the modules a2, a3, b1, and b2 is QM, and the safety standard of the component X3 is ASIL-D. By referring to the safety standard corresponding to the most recent execution time (the execution time TM2 in FIG. 9) in the safety standard information D5, it is possible to determine the safety standard that is currently required.

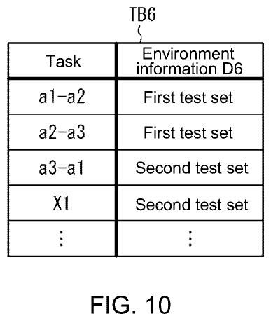

FIG. 10 is a table TB6 showing an example of the environment information D6 according to the embodiment. The environment information D6 is information in which a task Tx is associated with the test set 42 used in the test of the task Tx. The environment information D6 is provided from the execution unit 41 to the storage 50, for example, every time the execution unit 41 executes the test of the task Tx. For example, it is shown that an integration test for the modules a1 and a2 and an integration test for the modules a2 and a3 are executed using the first test set 42a, and an integration test for the modules a3 and a1 and a test for the component X1 are executed using the second test set 42b. Based on the environment information D6, it is possible to acquire the type of the test set 42 used in the test of the task Tx.

### Information Processing Method

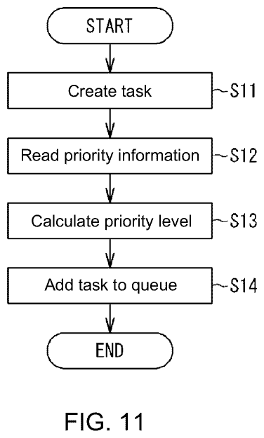

FIG. 11 is a flowchart showing an example of an information processing method executed by the information processing system 1. First, developers create a plurality of source code components using the terminal group 60, and store the source code components in the repository 20 via the network. The source code components are stored in the repository 20 at appropriate times.

The SCM that manages the repository 20 creates a task Tx, for example, periodically (also called polling processing) or when a new source code component is stored in the repository 20 (also called push processing) (step S11). For example, if the modules a1, a2, a3, b1, and b2 and the component X3 are already stored in the repository 20, and a new version of the module a1 is then stored in the repository 20, the SCM creates tasks Tx associated with the module a1. For example, the SCM creates a task Tx for executing an integration test on the modules a1 and a2, a task Tx for executing an integration test on the modules a1 and a3, a task Tx for executing a test on the component X1, and a task Tx for executing an integration test including the component X1 (e.g., an integration test executed on the components X1 and X2).

Thereafter, one or more of the created tasks Tx are provided from the repository 20 to the information processing device 10. Step S11 thus ends.

The communication unit 13 of the information processing device 10 outputs a task Tx received from the repository 20 to the control unit 11. Upon receiving a new input of a task Tx, the control unit 11 reads the priority information 51 from the storage 50 (step S12). The control unit 11 may read, for example, all of the information D1 to D6 included in the priority information 51, or may read only a portion of the information D1 to D6 that is to be used to calculate the priority level of the task Tx. The read priority information 51 is input to the control unit 11 via the communication unit 13. Step S12 thus ends.

Next, the control unit 11 calculates the priority level of the task Tx based on the priority information 51 (step S13). The priority level is calculated, for example, by at least one of the following first to fifth calculation examples. The control unit 11 may use two or more of the first to fifth calculation examples and calculate a plurality of types of priority levels based on a plurality of pieces of information from the information D1 to the information D6. Examples of calculation of the priority level will be described below.

### First Calculation Example: Prioritization of Task Left Unexecuted

The control unit 11 reads the execution time information D2 and calculates a higher priority level for a task Tx that has been left unexecuted for a long time (i.e., a task Tx for which a longer time has elapsed since the most recent test execution time). By executing testing earlier for a task Tx whose test has not been executed for a while, it is possible to prevent the scale of source revision from becoming large.

For example, in the case of FIG. 6, the most recent execution time TM1 of a task Tx related to an integration test for the modules a2 and a3 (in this calculation example, this is an example of a “second task” of the present disclosure and will be referred to as the task a2-a3 as appropriate) is earlier (older) than the most recent execution time TM2 of a task Tx related to an integration test for the modules a1 and a2 (in this calculation example, this is an example of a “first task” of the present disclosure and will be referred to as the task a1-a2 as appropriate).

Therefore, the control unit 11 calculates a higher priority level for the task a2-a3 than for the task a1-a2. In the case where a higher numerical value indicates a higher priority level for a task Tx, the control unit 11 assigns “2” as the priority level of the task a2-a3 and assigns “1” as the priority level of the task a1-a2, for example.

The control unit 11 may calculate the priority level according to the values of the execution times TM1 and TM2. For example, the time from the execution time point TM1 or TM2 to the present time may be used as the priority level value. In this case, since the time from the execution time TM2 to the present time is longer than the time from the execution time TM1 to the present time, a higher numerical value is calculated as the priority level of task a2-a3.

### Second Calculation Example: Prioritization of Quickly Executable Task

The control unit 11 reads the required time information D3, and calculates a higher priority level for a task Tx whose test can be executed more quickly. If the test of a task Tx that can be executed more quickly is executed earlier, it is possible to increase the number of tests executed per unit time and reduce the number of tasks waiting to be executed.

For example, in the case of FIG. 7, the time required to execute the test of the task Tx related to an integration test for the modules a1 and a2 (in this calculation example, this is an example of the “second task” of the present disclosure and will be referred to as the task a1-a2 as appropriate) is shorter than the time required to execute the test of the task Tx related to an integration test for the modules a2 and a3 (in this calculation example, this is an example of the “first task” of the present disclosure and will be referred to as the task a2-a3 as appropriate).

Therefore, the control unit 11 calculates a higher priority level for the task a1-a2 than for the task a2-a3. In the case where a higher numerical value is assigned to a task Tx as the priority level increases, the control unit 11 assigns “2” as the priority level of the task a1-a2 and assigns “1” as the priority level of the task a2-a3, for example.

The control unit 11 may calculate the priority level according to the value of the required time. For example, the priority level value may be a value obtained by subtracting the required time from a predetermined value E1. Here, the predetermined value E1 is set to a value that is sufficiently larger than each required time. In this case, the value obtained by subtracting the most recent required time for the task a1-a2 (e.g., 1 minute 6 seconds=66 seconds) from the predetermined value E1 (i.e., E1-66) is greater than the value obtained by subtracting the most recent required time for the task a2-a3 (e.g., 2 minutes 30 seconds=150 seconds) from the predetermined value E1 (i.e., E1-150), and therefore a higher numerical value is calculated as the priority level of task a1-a2. Note that when calculating the priority level, the control unit 11 may use the most recent value of the required time, or may use a statistical value of required times (e.g., an average value of several past required times).

### Third Calculation Example: Prioritization of Task With Recent Failure History

The control unit 11 reads the test result information D4 and calculates a higher priority level for a task Tx that has a more recent failure history. By executing the test of a failed task Tx earlier, it is possible to more quickly check whether or not the error has been resolved.

For example, in the case of FIG. 8, the most recent test result of task Tx related to an integration test for the components X1 and X2 (in this calculation example, this is an example of the “first task” of the present disclosure and will be referred to as the task X1-X2 as appropriate) is success, and the most recent test result of task Tx related to an integration test for the components X3 and X1 (in this calculation example, this is an example of the “second task” of the present disclosure and will be referred to as the task X3-X1 as appropriate) is failure.

Therefore, the control unit 11 calculates a higher priority level for the task X3-X1 than for the task X1-X2. In the case where a higher numerical value is assigned to a task Tx as the priority level increases, the control unit 11 assigns “2” as the priority level of the task X3-X1 and assigns “1” as the priority level of the task X1-X2, for example.

The control unit 11 may calculate the priority level according to the number of most recent consecutive failures. For example, the priority level may be determined by adding a constant (e.g., 1) to the number of most recent consecutive failures. In this case, since the number of most recent consecutive failures for the task X1-X2 is “0 ” (the most recent test result was success), the control unit 11 calculates “1” (=0+1) as the priority level of the task X1-X2. Furthermore, since the number of most recent consecutive failures for the task X3-X1 is “2”, the control unit 11 calculates “3” (=2+1) as the priority level of the task X3-X1. Accordingly, a higher priority level value is calculated for the task X3-X1, which has a history of more failures.

### Fourth Calculation Example: Prioritization of Task with Stricter Safety Standard

The control unit 11 reads the safety standard information D5 and calculates a higher priority level for a task Tx with a stricter safety standard. A task Tx with a stricter safety standard has a narrower range of values permitted in the test performed by the measurement unit 44, for example, and is more susceptible to errors. By executing the test of such a task Tx earlier, source errors can be found more quickly.

For example, in the case of FIG. 9, with respect to the source code components at the most recent execution times, the strictest safety standard is ASIL-D required for the component X3, and the next strictest is ASIL-A required for the module a1. QM required for the other source code components (e.g., the modules a2, a3, etc.) is the least strict.

Consider tasks Tx related to combinations of source code components as shown in FIG. 8. For example, in the case of performing an integration test for the modules a1 and a2, the safety standard required for the task a1-a2, which includes the modules a1 and a2, is ASIL-A (the safety standard of the module a1), which is the strictest among the standards required for the source code components included in the task a1-a2. Also, in the case of performing an integration test for the modules a2 and a3, the safety standard required for the task a2-a3, which includes the modules a2 and a3, is QM (the safety standard of the modules a2 and a3), which is the strictest among the standards required for the source code components included in the task a2-a3.

Accordingly, the safety standard required for the test of the task a1-a2 (in this calculation example, an example of the “second task” of the present disclosure) is stricter than the safety standard required for the test of the task a2-a3 (in this calculation example, an example of the “first task” of the present disclosure), and therefore the control unit 11 calculates a higher priority level for the task a1-a2 than for the task a2-a3. In the case where a higher numerical value is assigned to a task Tx as the priority level increases, the control unit 11 assigns “2” as the priority level of the task a1-a2 and assigns “1” as the priority level of the task a2-a3, for example.

The control unit 11 may calculate the priority level according to the strictness (level) of the safety standard. For example, the control unit 11 may assign “5” as the priority level of the task Tx, which requires the strictest ASIL-D, assign “4” for ASIL-C, assign “3” for ASIL-B, assign “2” for ASIL-A, and assign “1” for QM.

### Fifth Calculation Example: Prioritization of Task Requiring Fewer Test Sets

The control unit 11 reads the environment information D6, and calculates a higher priority level for a task Tx requiring fewer test sets 42 in the environment information D6. By executing a test that requires fewer test sets 42 earlier, it is possible to reduce the idle time of the scarce test sets 42.

For example, consider the case where the test environment 40 includes two first test sets 42a and one second test set 42b as shown in FIG. 4. In the example of FIG. 10, the number of second test sets 42b associated with the task Tx related to an integration test for the modules a3 and a1 (in this calculation example, an example of the “second task” in the present disclosure and referred to as the task a3-a1 as appropriate) is smaller than the number of first test sets 42a associated with the task Tx related to an integration test for the modules a1 and a2 (in this calculation example, an example of the “first task” in the present disclosure and referred to as the task a1-a2 as appropriate).

Therefore, the control unit 11 calculates a higher priority level for the task a3-a1 than for the task a1-a2. In the case where a higher numerical value is assigned to a task Tx as the priority level increases, the control unit 11 assigns “2” as the priority level of the task a3-a1 and assigns “1” as the priority level of the task a1-a2, for example.

The control unit 11 may calculate the priority level according to the number of test sets 42. For example, the priority level value may be a value obtained by subtracting the number of test sets 42 from a predetermined value E2. Here, the predetermined value E2 is set to a value that is sufficiently larger than each number of required test sets 42. In this case, the value obtained by subtracting the number of second test sets 42b (1) from the predetermined value E2 (i.e., E2-1) is greater than the value obtained by subtracting the number of first test sets 42a (2) from the predetermined value E2 (i.e., E2-2), and therefore a higher value is calculated as the priority level of the task a3-a1 associated with the second test set 42b.

### Addition of Task to Queue

The calculated priority level is stored in the storage unit 12, for example. Step S13 thus ends.

Next, the control unit 11 adds a task Tx to the queue 31 based on the priority level (step S14). For example, consider the case of adding a new task T4 to the queue 31 when the tasks T1, T2, and T3 are already stored in the queue 31 as shown in FIG. 1.

If the priority level of the task T4 is lower than that of the task T1 and higher than that of the task T2, the control unit 11 adds the task T4 to the queue 31 at a position after the task T1 and before the task T2 (i.e., between the task T1 and the task T2) in the execution order.

For example, when the priority level is calculated based on the “first calculation example” described above, if the priority level of the task T1 is “3”, the priority levels of the tasks T2 and T3 are both “1”, and the priority level of the new task T4 to be added is “2”, then the control unit 11 adds the task T4 between the task T1 and the task T2 as described above. As a result, the tasks Tx are held in the queue 31 in order of highest priority level, and therefore the tests of the tasks Tx can be executed in order of highest priority level.

Furthermore, in the case where the priority level is calculated based on multiple calculation examples, an importance level may be set in advance for each calculation example, and when adding a task Tx to the queue 31, the priority levels may be evaluated in descending order of importance level of the calculation example.

Here, consider the case where two types of priority levels are calculated using the first calculation example and the second calculation example respectively. For example, the importance level of a priority level calculated by the first calculation example (hereinafter referred to as the first priority level) is set higher than the importance level of a priority level calculated by the second calculation example (hereinafter referred to as the second priority level). This setting is performed by, for example, an operator who manages the information processing device 10, and the setting is stored in advance in the storage unit 12 as one of the parameters.

In this case, the control unit 11 first compares the first priority levels of the tasks T1, T2, and T3 stored in the queue 31 with the first priority level of the new task T4 to be added. For example, if the first priority level of the tasks T1, T2, and T3 is “2”, and the first priority level of the task T4 is also “2”, the first priority level alone cannot be used to identify an appropriate position for adding the task T4 to the queue 31.

Therefore, next, the control unit 11 compares the second priority levels of the tasks T1, T2, and T3 stored in the queue 31 with the second priority level of the new task T4 to be added. For example, if the second priority level of the task T1 is “3”, the second priority levels of the tasks T2 and T3 are “1”, and the second priority level of the newly added task T4 is “2”, the control unit 11 adds the task T4 between the task T1 and the task T2 as described above.

In this way, by using a plurality of types of priority levels and comparing the tasks Tx in order of the priority level with the highest importance level, it is possible to add the task Tx at a more suitable position in the queue 31. Note that if all of the priority levels are the same, the new task Tx may be added to the queue at a position after the currently held tasks Tx in the execution order, based on the FIFO method.

Also, when the priority level is calculated based on a plurality of calculation examples, a priority level “weight” may be set in advance for each calculation example, and the position at which a task Tx is added to the queue 31 may be determined based on an overall priority level calculated by adding up the priority levels with assigned weights.

For example, consider the case where the weight of the first priority level is set to “2” and the weight of the second priority level is set to “1”. In this case, the overall priority level is calculated as “first priority level×2+second priority level×1”. The weight of each priority level is set, for example, by an operator who manages the information processing device 10, and is stored in advance in the storage unit 12 as one of the parameters.

Step S14 thus ends. The tasks Tx stored in the queue 31 are output by the test tool 30 to the execution unit 41 at appropriate timing, and the tests are executed. In this way, the tests of the tasks Tx can be executed in order of highest priority level.

### MODIFIED EXAMPLES

Modified examples of the embodiment will be described below. In the modified examples, components the same as those in the above embodiment are denoted by the same reference numerals and descriptions thereof will be omitted.

### Modified Examples of Information Processing Method

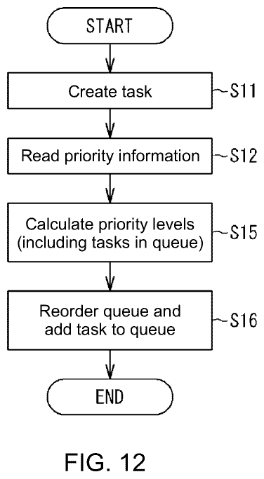

FIG. 12 is a flowchart showing an information processing method according to a modified example. In the above embodiment, for example, the priority level of the new task T4 to be added to the queue 31 is calculated and then compared with the respective priority levels (already calculated priority levels) of the tasks T1, T2, and T3 already held in the queue 31, thereby determining the position at which the task T4 is to be added.

In contrast to this, in this modified example, when the new task T4 is to be added to the queue 31, the priority levels of the tasks T1, T2, and T3 already held in the queue 31 are recalculated. Then, based on the priority levels, rather than simply adding the task T4 to the queue 31, the order of the tasks T1 to T3 in the queue 31 is rearranged.

As shown in FIG. 12, step S11 and step S12 are performed similarly to the above embodiment. Thereafter, the control unit 11 calculates the priority level of the task T4 similarly to step S13, and also recalculates the priority level of each of the tasks T1, T2, and T3 in the queue 31 (step S15).

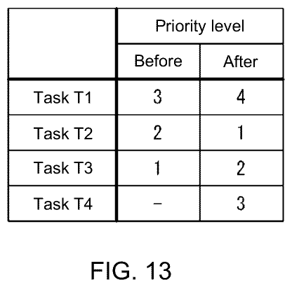

FIG. 13 is a diagram for describing priority levels of tasks according to this modified example. For example, it is assumed here that before the task T4 is added, the priority levels of the tasks T1, T2, and T3 already held in the queue 31 are “3”, “2”, and “1”, respectively. Then, in step S15, the priority level of the task T4 is calculated to be “3”, and the priority levels of the tasks T1, T2, and T3 are recalculated to be “4”, “1”, and “2”, respectively.

In this case, the control unit 11 rearranges the held order of the tasks T1 to T3 in the queue 31 based on the respective priority levels after step S15. Specifically, the control unit 11 rearranges the tasks T1, T3, and T2 in decreasing order of priority level. The control unit 11 then adds the task T4 at a position between the task T1 and the task T3. As a result, the final held order of the queue 31 is the tasks T1, T4, T3, and T2, in order of earliest test execution.

In this way, not only is the task T4 added to a more suitable position, but in the above example, the order of the tasks T2 and T3 is swapped. Therefore, every time a task Tx is to be added to the queue 31, the order of the tasks Tx already held in the queue 31 can be reviewed, and therefore the tests of the tasks Tx can be more reliably executed in order of highest priority level. This method is particularly suitable when there is a desire to expedite the execution of a task Tx that has been put off for a long time in the queue 31 (i.e., has been left unexecuted).

Note that if the priority levels of all of the tasks Tx in the queue 31 are recalculated every time a task Tx is to be added to the queue 31, an excessive processing load may be imposed on the control unit 11. Therefore, a configuration is possible in which the control unit 11 executes steps S15 and S16, for example, every time a predetermined number of tasks Tx are added to the queue 31, and executes steps S13 and S14 in other cases. Furthermore, a configuration is possible in which recalculation of the priority levels of the tasks Tx in the queue 31 is not performed during push processing, and recalculation of the priority levels of the tasks Tx in the queue 31 is performed only during polling processing. According to this configuration, it is possible to rearrange the tasks Tx in the queue 31 while also reducing the processing load on the control unit 11.

### Modified Examples of Task

The control unit 11 may divide a task Tx into a plurality of divided tasks DTx for respective test items, for example, and then calculate a priority level for each of the divided tasks DTx. The control unit 11 divides a task Tx into a plurality of divided tasks DTx based on, for example, at least one of the test environment used by the task Tx, the safety standard required for the task Tx, the results of the test of the task Tx, the execution time at which the test of the task Tx is executed, and the time required to execute the test of the task Tx.

The following describes an example of dividing a task Tx into divided tasks DTx based on the safety standard. As shown in FIG. 9, the safety standard required for a task Tx (hereinafter referred to as the task X3) related to an operation test for the component X3 is ASIL-D. However, ASIL-D is not required for all of the test items included in the task X3, and for example, the safety standard required for some of the test items included in the task X3 may be QM.

Therefore, when calculating the priority level, the control unit 11 divides the task X3 into divided tasks X3a and X3b for respective test items, for example, based on the safety standard. For example, the divided task X3a includes only the test items for which QM is required among the test items of the task X3. Also, the divided task X3b includes only the test items for which the safety standard of ASIL-A or higher (ASIL-A, B, C, D) is required among the test items of the task X3.

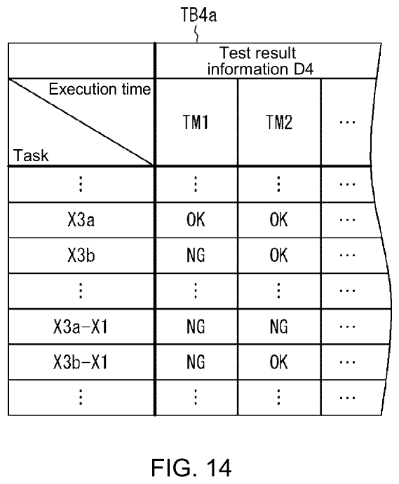

FIG. 14 is a table TB4a showing test result information D4 according to a modified example. In the table TB4a, the task X3 has been divided into the divided tasks X3a and X3b. Also, by dividing the test result information D4 for each of the divided tasks X3a and X3b, it is possible to check the test results in more detail, for example, that at the execution time TM1, the test result of the divided task X3a was successful and the test result of the divided task X3b was failure. This makes it easier to narrow down the portion of the task X3 in which an error has occurred, thus making it possible to respond to the error more quickly.

Also, in step S13, the control unit 11 may also calculate a priority level for each divided task TDx. Moreover, in step S14, the control unit 11 may determine the position at which the divided tasks TDx are to be newly added to the queue 31 based on the priority levels thereof and the priority levels of the divided tasks TDx already held in the queue 31. This allows for more granular testing.

### ADDITIONAL NOTES

This disclosure includes the content set forth in the following additional notes.

### Additional Note 1

An information processing device for supporting development of software to be executed by an in-vehicle device, the information processing device including: a control unit configured to add, to a queue for waiting for task test execution, a task provided from a repository storing a plurality of source code components included in the software, wherein the control unit reads, from a storage, priority information including information regarding the provided task, the control unit calculates a priority level for the provided task based on the priority information, and the control unit compares the priority level of a task already held in the queue with the priority level of the provided task to be newly added to the queue, and adds the provided task to the queue in such a manner that a task with a higher priority level is executed earlier in an execution order.

### SUPPLEMENTARY REMARKS

Note that at least some of the above-described embodiments and various modified examples may be combined with each other in any desired manner. Furthermore, the embodiments and modified examples disclosed herein should be considered as illustrative in all respects and not restrictive. The scope of the present disclosure is defined by the claims, and it is intended to include all modifications within the meaning and scope equivalent to the claims.

1. An information processing system for supporting development of software to be executed by an in-vehicle device, the information processing system comprising:
a control unit configured to add, to a queue for waiting for task test execution, a task provided from a repository storing a plurality of source code components included in the software,
wherein the control unit reads, from a storage, priority information including information regarding the provided task,
the control unit calculates a priority level for the provided task based on the priority information, and
the control unit compares the priority level of a task already held in the queue with the priority level of the provided task to be newly added to the queue, and adds the provided task to the queue in such a manner that a task with a higher priority level is executed earlier in an execution order.

2. The information processing system according to claim 1, wherein the in-vehicle device includes an in-vehicle ECU.

3. The information processing system according to claim 2, wherein the priority information includes information regarding at least one of a test environment, a past result of a test of a task, an execution time at which a test of a task was executed, and a required time indicating a duration of time required for execution of a test of a task.

4. The information processing system according to claim 1, wherein the priority information includes information regarding a vehicle safety standard required of a task.

5. The information processing system according to claim 3,
wherein there are a plurality of the tasks, including a first task and a second task whose most recent execution time is before a most recent execution time of the first task, and
the control unit calculates a higher priority level for the second task than for the first task.

6. The information processing system according to claim 3,
wherein there are a plurality of the tasks, including a first task and a second task whose required time is shorter than a required time of the first task, and
the control unit calculates a higher priority level for the second task than for the first task.

7. The information processing system according to claim 3,
wherein there are a plurality of the tasks, including a first task whose most recent result is successful and a second task whose most recent result is failure, and
the control unit calculates a higher priority level for the second task than for the first task.

8. The information processing system according to claim 3,
wherein the test environment includes
a test set including a circuit board and a measurement unit that measures operation of the circuit board, and
an execution unit that executes a test of a task output from the queue, by controlling the test set based on the output task,
the priority information includes environment information in which tasks are respectively associated with test sets used in tests of the tasks, and
the control unit calculates the priority level for the provided task based on the environment information.

9. The information processing system according to claim 8,
wherein there are a plurality of the test sets, including a plurality of first test sets and one or more second test sets, the number of second test sets being lower than the number of first test sets,
there are a plurality of the tasks, including a first task associated with a first test set among the plurality of first test sets in the environment information and a second task associated with a second test set among the one or more second test sets in the environment information, and
the control unit calculates a higher priority level for the second task than for the first task.

10. The information processing system according to claim 4,
wherein there are a plurality of the tasks, including a first task and a second task, the safety standard required of the second task being stricter than the safety standard required of the first task, and
the control unit calculates a higher priority level for the second task than for the first task.

11. The information processing system according to claim 10, wherein the safety standard includes ISO26262 Automotive Safety Integrity Levels.

12. The information processing system according to claim 5,
wherein the control unit calculates a priority level for each a plurality of tasks already held in the queue based on the priority information, and
the control unit rearranges the plurality of tasks already held in the queue in such a manner that a fourth task having a higher priority level than a third task is executed before the third task in the execution order.

13. The information processing system according to claim 5,
wherein the control unit divides the provided task into a plurality of divided tasks based on at least one of the test environment, the safety standard, the result, the execution time, and the required time,
the control unit calculates a priority level for each of the divided tasks based on the priority information, and
the control unit adds the plurality of divided tasks to the queue in such a manner that a second divided task having a higher priority level than a first divided task is executed before the first divided task in the execution order.

14. An information processing system for supporting development of software to be executed by an in-vehicle device, the information processing method comprising:
an adding step of adding, to a queue for waiting for task test execution, a task provided from a repository storing a plurality of source code components included in the software,
wherein the adding step includes
a first step of reading, from a storage, priority information including information regarding the provided task,
a second step of calculating a priority level for the provided task based on the priority information, and
a third step of comparing the priority level of a task already held in the queue with the priority level of the provided task to be newly added to the queue, and adding the provided task to the queue in such a manner that a task with a higher priority level is executed earlier in an execution order.

15. A computer program for supporting development of software to be executed by an in-vehicle device, the computer program causing a computer to execute:
an adding step of adding, to a queue for waiting for task test execution, a task provided from a repository storing a plurality of source code components included in the software,
wherein the adding step includes
a first step of reading, from a storage, priority information including information regarding the provided task,
a second step of calculating a priority level for the provided task based on the priority information, and
a third step of comparing the priority level of a task already held in the queue with the priority level of the provided task to be newly added to the queue, and adding the provided task to the queue in such a manner that a task with a higher priority level is executed earlier in an execution order.
